(19) United States
(12) Patent Application Publication
(10) Pub. No.: US 2011/0071837 A1
(43) Pub. Date: Mar. 24, 2011

(54) Audio Signal Correction Apparatus and Audio Signal Correction Method

(76) Inventors: Hiroshi Yonekubo, Tokyo (JP); Hirokazu Takeuchi, Machida-shi (JP)

(21) Appl. No.: 12/772,790

(22) Filed: May 3, 2010

(30) Foreign Application Priority Data
Sep. 18, 2009 (JP) 2009-217941

(51) Int. Cl. G10L 11/00

(52) U.S. Cl. 704/270; 704/E21.001

(57) ABSTRACT

According to one embodiment, an audio signal correction apparatus has a characteristic extraction module configured to determine whether an input audio signal is a monaural signal or a stereo signal, on the basis of channel information, and to extract a plurality of characteristic parameters for determining whether the input audio signal is a speech signal or a music signal, a signal type determination module configured to calculate a speech/music discrimination score which indicates whether the input audio signal is close to the speech signal or the music signal, on the basis of the plurality of characteristic parameters and a level calculation module configured to calculate, with use of the speech/music discrimination score, output levels of a degree of speech and a degree of music.

### CROSS-REFERENCE TO RELATED APPLICATIONS

This application is based upon and claims the benefit of priority from Japanese Patent Application No. 2009-217941, filed Sep. 18, 2009, the entire contents of which are incorporated herein by reference.

### FIELD

Embodiments described herein relate generally to an audio signal correction technique which adaptively performs a sound quality correction process on a speech signal and a music signal which are included in an audio signal.

### BACKGROUND

As is well known, for example, in broadcast reception apparatuses which receive television broadcast and information playback apparatuses which reproduce recorded information from information recording media, when an audio signal is to be reproduced from a received broadcast signal or from a signal read from the information recording media, a sound quality correction process is executed on the audio signal, thereby enhancing the sound quality.

In this case, the content of the sound quality correction process, which is to be executed on the audio signal, varies depending on whether the audio signal is a speech signal such as a voice of a person, or a music (non-speech) signal such as a song. Specifically, the sound quality of the speech signal is improved by subjecting the speech signal to such a sound quality correction process as to emphasize and clarify a central normal-position component, as in the case of a talk scene or sports broadcast, and the sound quality of the music signal is improved by subjecting the music signal to such a sound quality correction process as to emphasize a stereophonic effect with the impression of a spatial distribution of sound.

It is thus thought to discriminate whether an acquired audio signal is a speech signal or a music signal, and to perform a sound quality correction process corresponding to the determination result. However, in an actual audio signal, a speech signal and a music signal are mixed in many cases, and it is difficult to discriminate these signals. This being the case, a proper sound quality correction process has not always been executed on the audio signal.

Jpn. Pat. Appln. KOKAI Publication No. 2007-67858 discloses a structure which determines whether an audio signal is a speech or not, on the basis of the degree of the likelihood of speech and the degree of the likelihood of music, and to optimize the determination of speech/non-speech according to whether the audio signal is a monaural signal or a stereo signal.

### BRIEF DESCRIPTION OF THE DRAWINGS

FIG. 1 is a block diagram schematically showing the structure of a digital television broadcast reception apparatus according to an embodiment;

FIG. 2 is a block diagram schematically showing the structure of an audio processing module according to the embodiment;

FIG. 3 is a flow chart illustrating a characteristic parameters extraction process according to the embodiment;

FIG. 4 is a flow chart illustrating a signal type determination process according to the embodiment; and

FIG. 5 is a flow chart illustrating a level calculation process according to the embodiment.

### DETAILED DESCRIPTION

In general, according to one embodiment, an audio signal correction apparatus has a characteristic extraction module configured to determine whether an input audio signal is a monaural signal or a stereo signal, on the basis of channel information, and to extract a plurality of characteristic parameters for determining whether the input audio signal is a speech signal or a music signal, a signal type determination module configured to calculate a speech/music discrimination score which indicates whether the input audio signal is close to the speech signal or the music signal, on the basis of the plurality of characteristic parameters, a level calculation module configured to calculate, with use of the speech/music discrimination score, output levels of a degree of speech and a degree of music and a sound quality correction module configured to apply a sound quality correction process to the input audio signal on the basis of the output levels.

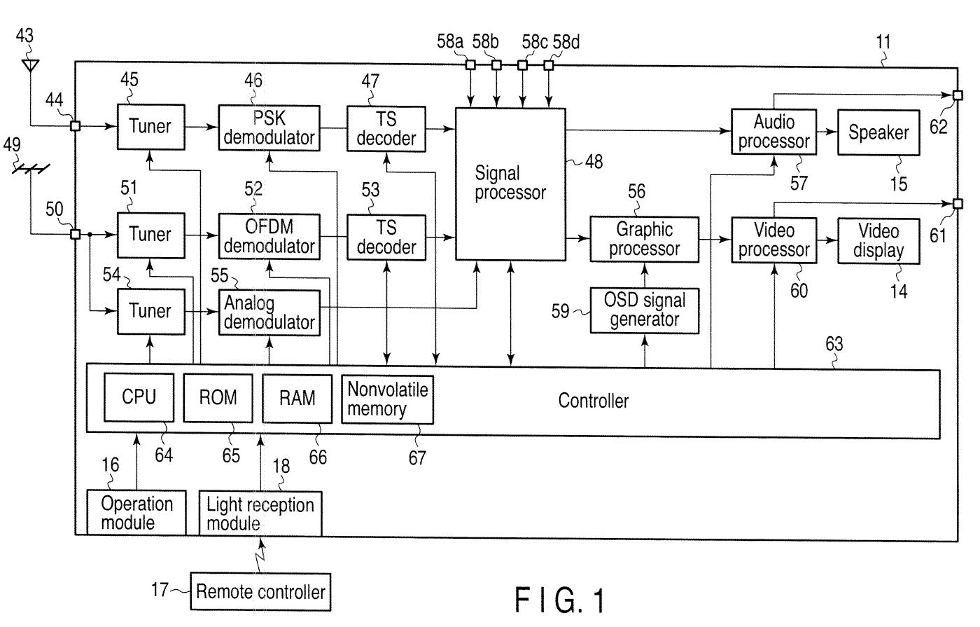

An embodiment will now be described in detail with reference to the accompanying drawings. FIG. 1 shows a main signal processing system of a digital television broadcast receiver 11. Specifically, a satellite digital television broadcast signal, which has been received by an antenna 43 for receiving BS/CS (broadcasting satellite/communication satellite) digital broadcast, is supplied to a tuner 45 for satellite digital broadcast via an input terminal 44, and thereby a broadcast signal of a desired channel is selected.

The broadcast signal, which has been selected by the tuner 45, is supplied successively to a PSK (phase shift keying) demodulator 46 and a TS (transport stream) decoder 47, and is thus demodulated to a digital video signal and audio signal, and then output to a signal processor 48.

In addition, a terrestrial digital television broadcast signal, which has been received by an antenna 49 for receiving terrestrial broadcast, is supplied to a tuner 51 for terrestrial digital broadcast via an input terminal 50, and thereby a broadcast signal of a desired channel is selected.

The broadcast signal, which has been selected by the tuner 51, is successively supplied, for example, in Japan, to an OFDM (orthogonal frequency division multiplexing) demodulator 52 and a TS decoder 53, and is thus demodulated to a digital video signal and audio signal, and then output to the signal processor 48.

Besides, a terrestrial analog television broadcast signal, which has been received by the antenna 49 for receiving terrestrial broadcast, is supplied to a tuner 54 for terrestrial analog broadcast via the input terminal 50, and thereby a broadcast signal of a desired channel is selected. The broadcast signal, which has been selected by the tuner 54, is supplied to an analog demodulator 55 and demodulated to an analog video signal and audio signal, and then output to the signal processor 48.

The signal processor 48 selectively performs a predetermined digital signal process on the digital video signal and audio signal, which are supplied from the TS decoder 47, 53, and outputs the resultant processed video signal and audio signal to a graphic processor 56 and an audio processor 57.

A plurality (four in the example shown) of input terminal 58a, 58b, 58c and 58d are connected to the signal processor 48. The input terminals 58a to 58d enable analog video signals and audio signals to be input from the outside of the digital television broadcast reception apparatus 11.

The signal processor 48 selectively digitizes analog video signals and audio signals, which are supplied from the analog demodulator 55 and input terminals 58a to 58d, performs a predetermined digital signal process on the digitized video signal and audio signal, and then outputs the resultant processed signals to the graphic processor 56 and audio processor 57.

The graphic processor 56 has a function of superimposing an OSD (on-screen display) signal, which is generated by an OSD signal generator 59, on a digital video signal which is supplied from the signal processor 48, and outputting the resultant signal. The graphic processor 56 can selectively output one of the output video signal of the signal processor 48 and the output OSD signal of the OSD signal generator 59, and can output both output signals in such a combination that both output signals constitute the halves of a screen.

The digital video signal, which is output from the graphic processor 56, is supplied to a video processor 60. The video processor 60 converts the input digital video signal to an analog video signal of a format which can be displayed on a display 14, and outputs the analog video signal to the display 14, thus causing the analog video signal to be displayed on the display 14. In addition, the video processor 60 outputs the analog video signal to the outside via an output terminal 61.

The audio processor 57 performs a sound quality correction process (to be described later) on the input digital audio signal, and converts the processed signal to an analog audio signal of a format which can be reproduced by a speaker 15. The analog audio signal is output to the speaker 15 and is reproduced, and is output to the outside via an output terminal 62.

All the operations of the digital television broadcast reception apparatus 11, including the above-described various receiving operations, are comprehensively controlled by a controller 63. The controller 63 includes a CPU (central processing unit) 64, receives operation information from an operation module 16 or operation information that is sent from a remote controller 17 and received by a light reception module 18, and controls the respective components so that the operation content of the operation information may be reflected.

In this case, the controller 63 mainly makes use of a ROM (read-only memory) 65 which stores a control program that is executed by the CPU 64, a RAM (random access memory) 66 which provides a working area for the CPU 64, and a nonvolatile memory 67 which stores various setting information and control information.

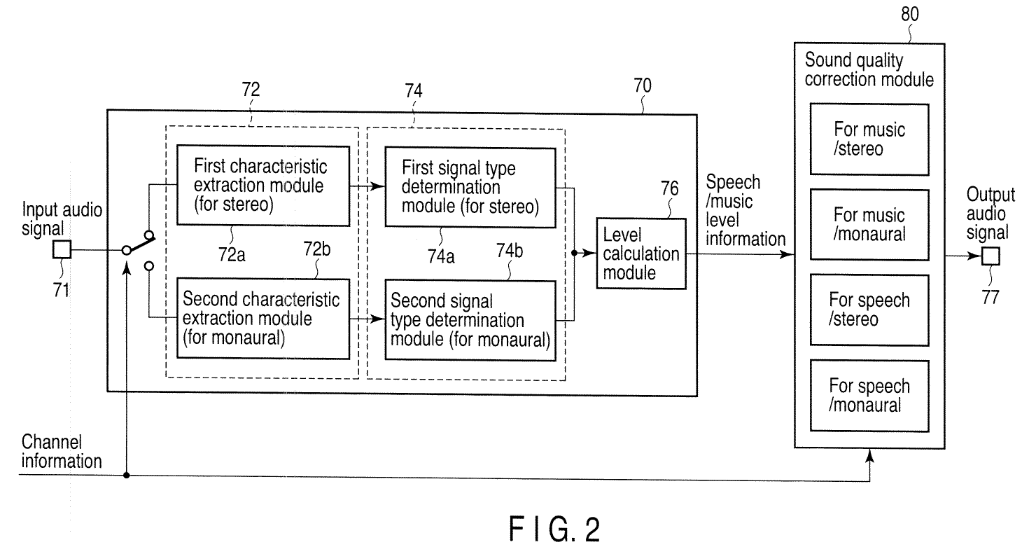

FIG. 2 shows a structure wherein a signal characteristic analysis module 70 and a sound quality correction module 80 are included in the audio processor 57. The signal characteristic analysis module 70 includes a characteristic extraction module 72, a signal type determination module 74 and a level calculation module 76. Further, the characteristic extraction module 72 includes a first characteristic extraction module 72a and a second characteristic extraction module 72b. The signal type determination module 74 includes a first signal type determination module 74a and a second signal type determination module 74b. An input audio signal is supplied to an input terminal 71. The controller 63 supplies the input audio signal to the characteristic extraction module 72. The controller 63 supplies channel information (monaural/stereo signal information) of the input audio signal to the respective modules that constitute the signal characteristic analysis module 70.

In the case where the input audio signal is a stereo signal, the first characteristic extraction module 72a calculates various characteristic parameters for determining whether the input audio signal is a speech signal or a music signal. In the case where the input audio signal is a monaural signal, the second characteristic extraction module 72b calculates various characteristic parameters for determining whether the input audio signal is a speech signal or a music signal. The characteristic extraction module 72 effects switching between the first characteristic extraction module 72a and the second characteristic extraction module 72b, according to whether the input audio signal is a stereo signal or a monaural signal.

The first signal type determination module 74a determines whether the input audio signal (stereo signal) is a speech signal or a music signal. Similarly, the second signal type determination module 74b determines whether the input audio signal (monaural signal) is a speech signal or a music signal. The signal type determination module 74 effects switching between the first signal type determination module 74a and the second signal type determination module 74b, according to whether the input audio signal is a stereo signal or a monaural signal.

The level calculation module 76 calculates speech/music level information including likelihood information for finely controlling the sound quality with respect to the speech signal or music signal. The level calculation module 76 outputs the speech/music level information to the sound quality correction module 80.

In the present embodiment, the first characteristic extraction module 72a and second characteristic extraction module 72b are configured as different modules, and the first signal type determination module 74a and second signal type determination module 74b are configured as different modules. However, the first characteristic extraction module 72a and second characteristic extraction module 72b may be configured as a single module, and the first signal type determination module 74a and second signal type determination module 74b may be configured as a single module.

On the basis of the speech/music level information calculated by the signal characteristic analysis module 70, the sound quality correction module 80 executes a sound quality correction process. The sound quality correction module 80 supplies an output audio signal, which has been subjected to the sound quality correction process, to an output terminal 77.

In short, the signal characteristic analysis module 70 and sound quality correction module 80 have the function of executing scene-adaptive sound quality correction which realizes the enhancement of sound quality by discriminating, without a processing delay, a music section and a speech section in the broadcast reception or in the reproduction of content from recording media, and performing a proper sound quality correction process on the input audio signal in accordance with the content of scenes.

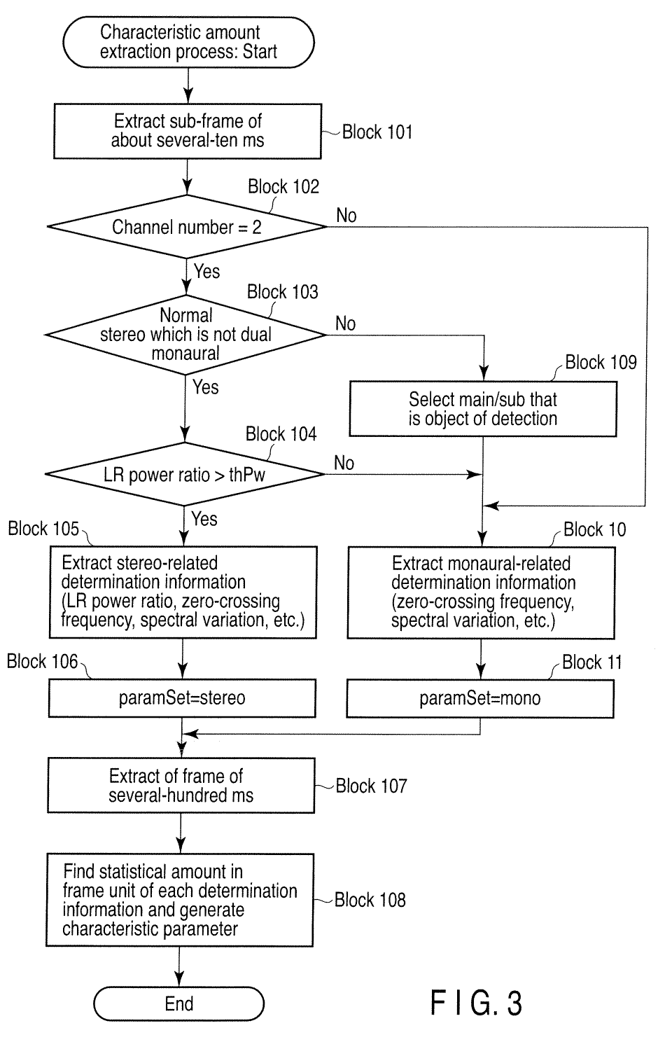

Next, a description is given of the operations of the first characteristic extraction module 72a and second characteristic extraction module 72b. FIG. 3 is a flow chart illustrating a characteristic extraction process. To start with, the characteristic extraction module 72 divides the input audio signal into frames at intervals of about several-hundred msec. Further, the characteristic extraction module 72 divides each frame into sub-frames at intervals of about several-ten msec (Block 101). For example, one sub-frame is 20 msec.

On the basis of the channel information of the input audio signal, the characteristic extraction module 72 determines whether the number of channels (“channel number”) of the input audio signal is 2 or not (i.e. a monaural signal or a stereo signal) (Block 102). It is presupposed that in the case where an input audio signal, which is demodulated, for example, from a broadcast signal selected by the tuner 51, is a multi-channel stereo signal, the signal processor 48 executes a process of downmixing the multi-channel stereo signal to a 2-channel stereo signal. The signal processor 48 supplies a 2-channel stereo signal as an input audio signal to the input terminal 71.

In the case where the channel number is 2 (YES in Block 102), the characteristic extraction module 72 determines whether or not the input audio signal is a normal stereo signal which is not a dual monaural signal (Block 103). The dual monaural signal is such a monaural signal that the channel number of the signal is 2, but sounds, which are superimposed, respectively, on a main channel and a sub-channel, are separate.

In the case where the input audio signal is a normal stereo signal which is not a dual monaural signal (YES in Block 103), the characteristic extraction module 72 calculates a power ratio (LR power ratio) of left and right (LR) 2-channel stereo signals of the input audio signal in units of a sub-frame. There is a case in which an input audio signal, which has a stereo signal format, is actually transmitted like a monaural signal. In this case, signals in the LR channels are substantially equal, and the determination by the characteristic extraction module 72 is not possible on the basis of the channel number alone. Thus, the characteristic extraction module 72 calculates the LR power ratio by dividing a difference component value of the LR channels by a sum component value, and compares the LR power ratio with a preset threshold thPw. Then, the characteristic extraction module 72 determines whether the LR power ratio is greater than the threshold thPw (Block 104).

In the case where the LR power ratio is greater than the threshold thPw (YES in Block 104), the first characteristic extraction module 72a extracts stereo-related determination information from a stereo signal having the LR power ratio greater than the threshold thPw (Block 105). In the present embodiment, it is assumed that the stereo signal means a signal which has the channel number of 2 and is, not a dual monaural signal, but a signal having strong stereophonic characteristics with the power ratio of the LR channels which is greater than a predetermined level.

The first characteristic extraction module 72a calculates determination information, such as the LR power ratio (sum of squares of signal amplitude) in units of a sub-frame, the zero crossing frequency which is the number of times by which the time-based waveform of the input audio signal crosses zero in the amplitude direction in units of a sub-frame, and the spectral component variation in the frequency region of the input audio signal in units of a sub-frame. The contents of the determination information are not limited to these examples, and additional determination information may be used.

The first characteristic extraction module 72a sets a variable paramSet=stereo, which is indicative of the stereo-related determination information, for the input audio signal (Block 106). The characteristic extraction module 72 combines sub-frames and extracts a frame at intervals of about several-hundred msec (Block 107). Subsequently, the characteristic extraction module 72 finds statistical characteristic values. (e.g. average, variance, maximum, minimum, etc.) in a frame unit from the stereo-related determination information or monaural-related determination information, and generates a characteristic parameter set (Block 108). The characteristic extraction module 72 finishes the characteristic extraction process.

In the case where the input audio signal is a dual monaural signal and is not a normal stereo signal (NO in Block 103), the second characteristic extraction module 72b receives main/sub selection information which is determined by the user, and determines the focus of the channel that is the object of detection (Block 109). The second characteristic extraction module 72b extracts monaural-related determination information with respect to the associated one of the main/sub channels (Block 110). Similarly, in the case where the channel number is not 2 (i.e. the channel number is 1) (NO in Block 102), the second characteristic extraction module 72b extracts monaural-related determination information (Block 110). Likewise, in the case where the LR power ratio is not greater than the threshold thPw (NO in Block 104), the second characteristic extraction module 72b extracts monaural-related determination information (Block 110).

The second characteristic extraction module 72b calculates determination information, such as the zero crossing frequency and the spectral component variation, in units of a sub-frame. The contents of the determination information are not limited to these examples, and additional determination information may be used.

The second characteristic extraction module 72b sets a variable paramSet=mono, which is indicative of the monaural-related determination information, for the input audio signal (B111). Subsequently, the second characteristic extraction module 72b continues the operation beginning with Block 107.

The stereo-related determination information and the monaural-related determination information are partly common and partly unique. An example of the unique characteristic parameter of the stereo-related determination information is the LR power ratio. There is a tendency that the LR power ratio increases in the music section and decreases in the speech section.

As has been described above, the characteristic extraction module 72 extracts, as well as the channel information of the input audio signal, the stereo-related determination information or monaural-related determination information in accordance with the content of the input audio signal, and generates the characteristic parameter set on the basis of the extracted determination information. Accordingly, the characteristic extraction module 72 can select the most suitable determination information for the use in determining whether the input audio signal is a speech signal or a music signal. The various characteristic parameter set, which is generated by the characteristic extraction module 72, is supplied to the signal type determination module 74.

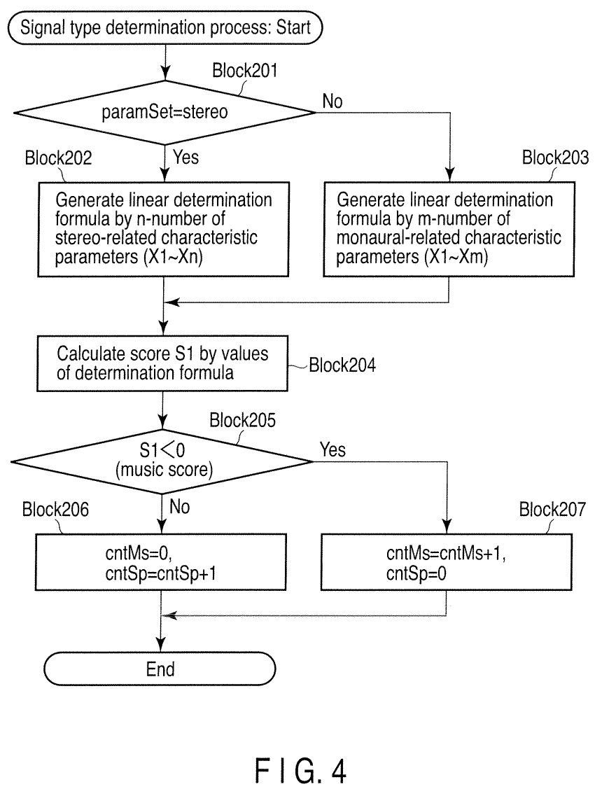

Next, the operation of the signal type determination module 74 is described. FIG. 4 is a flow chart illustrating the signal type determination process using the characteristic parameter set and channel information. To start with, the signal type determination module 74 determines whether paramSet=stereo is set for the input audio signal (Block 201). In the case where paramSet=stereo is set (YES in Block 201), the first signal type determination module 74a calculates a stereo-related linear determination formula, as will be described below (Block 202).

The stereo-related linear determination formula is used for the calculation of a speech/music discrimination score S1 which is used in order for the signal type determination module 74 to determine whether the input audio signal is a speech signal or a music signal. The signal type determination module 74 applies weighting coefficients, which correspond to the degree of importance of each of characteristic parameters, to the characteristic parameter set that is generated by the characteristic extraction module 72, and obtains a linear sum of values multiplied by the coefficients, thereby calculating the speech/music discrimination score S1 representing the likelihood of belonging to music/speech. The signal type determination module 74 determines the weighting coefficients by learning with use of data in which music/speech sound type expectation values are made clear in advance.

As the weighting coefficient, a greater value is given to a characteristic parameter which has a higher effect in the determination of the signal type. For example, the signal type determination module 74 makes use a stereo-related linear determination formula, as shown below. In addition, as regards the speech/music discrimination score S1, the weighting coefficient is calculated by inputting many prepared known speech signals and music signals as reference data, and learning characteristic parameters with respect to the reference data.

The characteristic parameter set of the k-th frame of the reference data that is the object of learning is expressed by a vector x, and a signal section {speech, music}, to which the input audio signal belongs, is expressed by y, as shown below.

x^{k}=(1,x₁^{k},x₂^{k}, . . . ,xₙ^{k} (1)

y^{k}={−1,+1} (2)

The elements in the formula (1) correspond to an n-number of characteristic parameters which are extracted. In the formula (2), “−1” and “+1” correspond to the speech section and music section, and a 2-value label is manually added in advance with respect to the section of the correct signal type of the speech/music learning data that is used. Since the “−1” and “+1” in the formula (2) are definitions for the purpose of convenience, these values may be reversed. Moreover, from the formula (2), the following linear discrimination function is established.

f(x)=β₀+β₁x₁+β₂x₂+ . . . +βₙxₙ (3)

With respect to k=1˜N (N is an input frame number of reference data), the vector x is extracted, and a normal equation, in which the evaluation value of the formula (3) and the error sum of squares of the formula (4) of the correct signal type formula (2) become minimum, is solved. Thereby, the weighting coefficient βᵢ (i=0˜n) for each characteristic parameter is determined.

$$E sum = {\sum }_{k = 1}^{N} {( {y}^{k} - f ( {x}^{k} ) )}^{2} \qquad ( 4 )$$

In the case where paramSet=stereo is not set (i.e. paramSet=mono is set) (NO in Block 201), the second signal type determination module 74b calculates a monaural-related linear determination formula by using the formula (4) from the formula (1) in the same manner as described above (Block 202). At this time, the second signal type determination module 74b calculates a monaural-related linear determination formula by an m-number of characteristic parameters, unlike the stereo-related linear determination formula (Block 203).

The signal type determination module 74 calculates the evaluation value of the actually discriminated input audio signal in units of a frame by the formula (3) by using weighting coefficients which are determined by learning, with respect to the stereo-related linear determination formula or monaural-related linear determination formula (Block 204). In this case, f(x) corresponds to the above-described speech/music discrimination score S1.

In the meantime, the method of calculating the speech/music discrimination score S1 is not limited to the method of multiplying the characteristic parameters by the weighting coefficients which are obtained by off-line learning using the above-described linear discrimination function. For example, use may be made of a method of setting empirical threshold values for the calculated values of the respective characteristic parameters, and imparting weighted points to the characteristic parameters in accordance with the determination of comparison with the threshold values, thereby calculating the score.

The signal type determination module 74 determines whether S1<0, or not (Block 205). The signal type determination module 74 determines a music section if S1<0, and determines a speech section if f(x)>0. The signal type determination module 74 exclusively determines whether each frame is a speech section or a music section.

Not in the case of S1<0 (i.e. in the case of a speech section) (NO in Block 205), the signal type determination module 74 increments a variable cntSp (Block 206). In the case of S1< (i.e. in the case of a music section) (YES in Block 205), the signal type determination module 74 increments a variable cntMs.

The speech/music discrimination score S1 that is calculated by the signal type determination module 74 and the incremented variable are supplied to the level calculation module 76. The signal type determination module 74 finishes the signal type determination.

The signal type determination module 74 selects different characteristic parameter sets according to whether the input audio signal, which has been determined on the basis of the channel information, is a stereo signal or a monaural signal. The effectiveness of the selection of characteristic parameters by the signal type determination module 74 is explained.

For example, the number n of characteristic parameters of the stereo-related characteristic parameter set is different from the number m of characteristic parameters of the monaural-related characteristic parameter set. As has been described above, in the case where the input audio signal is a stereo signal, the signal type determination module 74 uses the characteristic parameter set including the statistical characteristic calculated from the LR power ratio that is the determination information. Thus, the improvement of the detection precision of the speech/music discrimination score S1 can be expected. On the other hand, in the case where the input audio signal is a monaural signal, the improvement of the detection precision of the speech/music discrimination score 51 cannot be expected even if the signal type determination module 74 uses the characteristic parameter set including the statistical characteristic calculated from the LR power ratio. Conversely, the detection precision may possibly lower.

Formula (5) is an example in which the first signal type determination module 74a determines the weighting coefficient βᵢ corresponding to the degree of importance of each characteristic parameter, and applies it to the formula (3). It is assumed that ηₙ is a characteristic parameter in the LR power ratio.

f(x)=0.5+0.8x₁−0.3x₂+ . . . −1.2x (5)

As indicated in the formula (2), if the value of the linear discrimination function is negative, the degree of the likelihood of music of the input audio signal increases. In the case of a normal stereo music signal, different musical sounds are distributed to LR channels, and the LR power ratio tends to increase.

This tendency generally applies to any kind of stereo music. As a result of learning, the value of the weighting coefficient corresponding to the characteristic parameter in the LR power ratio tends to become relatively greater than the values of the weighting coefficients with which the other characteristic parameters indicate the determination of the music section/speech section. In other words, the characteristic parameter in the LR power ratio has a higher degree of contribution to the determination of the music section/speech section than the other characteristic parameters. Accordingly, the value of the linear discrimination function tends to have a larger negative value.

On the other hand, even in the case where the input audio signal is a music signal, if this music signal is a monaural signal, the characteristic parameter ηₙ is omitted. The second signal type determination module 74b calculates, in usual cases, the value of the linear discrimination function by substituting the value of 0 for ηₙ. Specifically, as regards the value of the linear discrimination function, the term of the characteristic parameter in the LR power ratio does not contribute to the determination of the music section/speech section. The precision of detection of the music section/speech section by the second signal type determination module 74b lowers. The second signal type determination module 74b determines the value of the weighting coefficient by taking into account the contribution to the determination of the music section/speech section with respect to each of the characteristic parameters. The characteristic parameter in the LR power ratio has a relatively higher degree of contribution to the determination of the music section/speech section than the other characteristic parameters. If the term of the characteristic parameter in the LR power ratio is omitted from the linear discrimination function, it becomes difficult for the second signal type determination module 74b to determine the music section/speech section.

To cope with this, the second signal type determination module 74b finds the weighting coefficient value by the formula (1) to formula (4) by using the characteristic parameter set excluding the term of the characteristic parameter of the LR power ratio (i.e. the characteristic parameter set comprising characteristic parameters which are common to the monaural signal and stereo signal and are expected to have effects, and characteristic parameters which are unique to the monaural signal).

Since the characteristic parameter of the LR power ratio is absent in the second signal type determination module 74b, the second signal type determination module 74b can give a coefficient value, which indicates the degree of likelihood of music more strongly, by that much, than the weighting coefficient value indicated in the formula (5), to a specific characteristic parameter of the other characteristic parameters. Therefore, the second signal type determination module 74b can suppress a decrease in detection precision of the music section/speech section.

As has been described above, the signal type determination module 74 can prepare optimal weighting coefficients in accordance with the stereo signal or monaural signal, and can selectively use the linear determination formula in accordance with the channel information of the input audio signal.

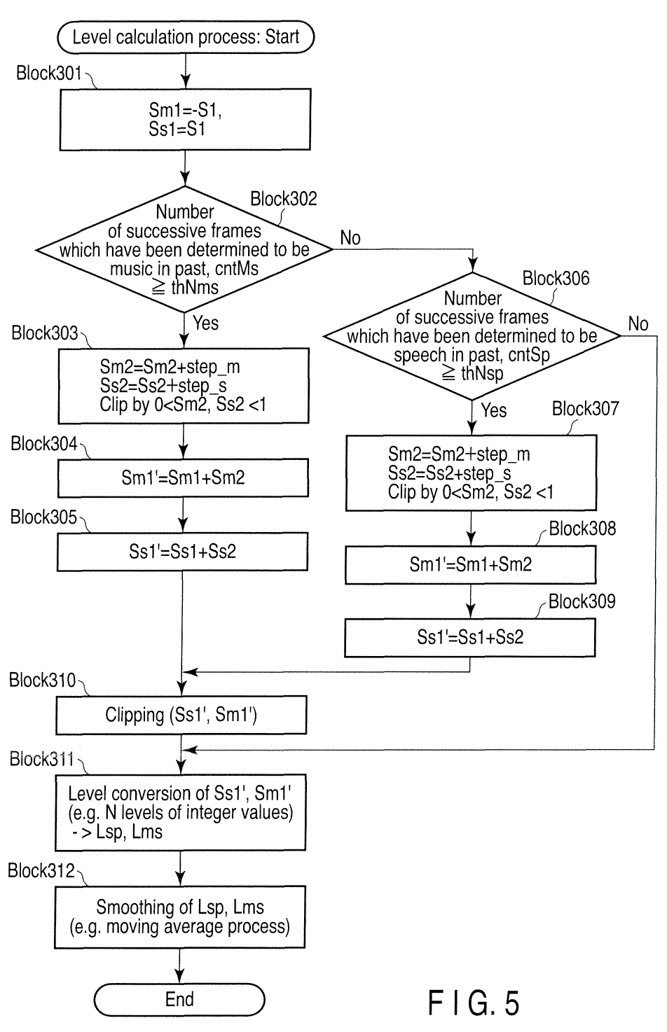

Next, the operation of the level calculation module 76 is described. FIG. 5 is a flow chart illustrating a level calculation process. The level calculation module 76 can determine the speech section if the value of the linear discrimination function, which is obtained by the formula (5), is positive, and can determine the music section if the value of the linear discrimination function is negative. However, in order for the controller 63 to finely control the sound quality of the speech that is output from the speaker 15, it is desirable for the level calculation module 76 to calculate the value of the linear discrimination function in a form of likelihood information which is expressed in a stepwise manner. In the case of the monaural signal, the music characteristic does not appear as a characteristic parameter so much conspicuously as in the case of the stereo signal. Accordingly, the score of the likelihood of music of the value S1 of the linear discrimination function tends to have a relatively small value. It is thus possible that the determination by the level calculation module 76 tends to become unstable depending on songs. To cope with this, the level calculation module 76 calculates the speech/music level, which also realizes stabilization of the score as described below.

The level calculation module 76 calculates the likelihood information of the music section and speech section on the basis of the value S1 of the linear discrimination function that is found by the linear determination formula. In this case, Sm1 is a score variable for music, and Ss1 is a score variable for speech. The level calculation module 76 sets Sm1=−S1, and Ss1=S1 (Block 301). In Sm1, the sign of S1 is inverted because it is easy to handle speech and music which are expressed in a positive value level.

While the level calculation module 76 calculates the speech/music discrimination score S1 in units of a frame with respect to Sm1 (>0), the level calculation module 76 counts the frame number cntMs of frames which have been successively determined to be music in the past. The level calculation module 76 determines whether cntMs has become a predetermined number thNsm or more (Block 302).

When cntMs has reached thNms (YES in Block 302), the level calculation module 76 adds the correction score Sm2 (>0), which is added to Sm1, by step_m (>0). The level calculation module 76 reduces the correction score Ss2 (>0), which is added to Ss1, by step_s (>0). The level calculation module 76 clips the values of Sm2 and Ss2 in a range of proper values (e.g. min=0, max=1) (Block 303).

Thereby, even in the case where the score variable for music, which is indicated by Sm1, is a relatively small value, the value of the score variable for music, after correction, is stabilized with the passing of time.

As in formula (6), the level calculation module 76 adds the corrected score Sm2 to the score variable Sm1 for music (Block 304).

Sm1′=Sm1+Sm2 (6)

As in formula (7), the level calculation module 76 adds the correction score Ss2 to the score variable Ss1 for music (Block 305).

Ss1′=Ss1+Ss2 (7)

In the case where cntMs does not reach thNms (NO in Block 302), the level calculation module 76 counts the frame number cntSp of frames, which have successively been determined to be speech in the past, with respect to Ss1 (>0). The level calculation module 76 determines whether cntSp has reached a predetermined number thNsp or more (Block 306).

When cntSp has reached thNsp (YES in Block 306), the level calculation module 76 reduces the correction score Sm2 (>0), which is added to Sm1, by step_m (>0). The level calculation module 76 adds the correction score Ss2 (>0), which is added to Ss1, by step_s (>0). The level calculation module 76 clips the values of Sm2 and Ss2 in a range of proper values (e.g. min=0, max=1) (Block 307).

Since the level calculation module 76 reduces the correction scope Sm2 in a stepwise manner, the level calculation module 76 has the effect of relaxing a sharp correction sound quality variation at a time of a change from a music section to a speech section.

As in formula (8), the level calculation module 76 adds the correction score Sm2 to the score variable Sm1 for music (Block 308).

Sm1′=Sm1−Sm2 (8)

As in formula (9), the level calculation module 76 adds the correction score Ss2 to the score variable Ss1 for speech (Block 309). The level calculation module 76 can stabilize the speech/music level by adding the correction score Ss2 in accordance with the continuity of determination.

Ss1′=Ss1+Ss2 (9)

the correction score Sm2 and Ss2 are values to correct the score variable Sm1 and Ss1 calculated on the basis of the monaural-related linear determination formula or the stereo-related linear determination formula in accordance with the continuity of determination, respectively. The level calculation module 76 sets higher the correction score Sm2 and lower the correction score Ss2, when the level calculation module 76 successively determines to be music at Block 302. The level calculation module 76 sets lower the correction score Sm2 and higher the correction score Ss2, when the level calculation module 76 successively determines to be speech at Block 306. When the level calculation module 76 can not successively determine to be music or speech at Block 302 or 306 respectively, the level calculation module 76 decreases the correction score Sm2 and Ss2 by degree. When the correction score Sm2 and Ss2 finally approach to zero as lower limit, the correction score Sm2 and Ss2 become invalidity.

Next, the level calculation module 76 clips Ss1′ and Sm1′ in a range of between 0 and 1 in order to properly convert Ss1′ and Sm1′ to a form which is easy to handle in a subsequent stage (Block 310). The level calculation module 76 converts Ss1′ and Sm1′ to desired resolution levels (Block 311). For example, the level calculation module 76 converts Ss1′ and Sm1′ to a music level Lms and a speech level Lsp as integer values of an N-number of levels, for example, from 0 to 255.

The level calculation module 76 performs smoothing in the process of level value conversion (Block 312). The level calculation module 76 performs smoothing in order to suppress a sharp variation in speech/music level between frames. Specifically, in the case of performing smoothing with a number (num_fr) of frames in the past, the level calculation module 76 multiplies the speech/music levels of the number (num_fr) of frames by weighting coefficients, respectively, and setting values of moving average as ultimate output levels (music level Lms, speech level Lsp). In this case, the level calculation module 76 sets higher weighting coefficients, by which the speech/music level is to be multiplied, for later past frames.

By the above-described score correction and smoothing, the level calculation module 76 can obtain stable speech/music levels with a low delay and low overhead. The signal type determination module 74 exclusively calculates the result of music/speech on the basis of 2-value determination result by the formula (3). However, since the level calculation module 76 independently performs score correction and smoothing on the speech/music level information, the level calculation module 76 can calculate the speech/music levels as mutually non-exclusive independent values with the passing of time. For example, in a section such as a BGM section, the level calculation module 76 outputs the music/speed levels as the likelihoods corresponding to the sound components thereof.

Further, the level calculation module 76 may control the speech/music levels in accordance with the content of the input audio signal to which detection is applied, or in accordance with the kind of content to which the input audio signal belongs. For example, if the input audio signal is a monaural signal, with which the effect of music correction can be obtained relatively less easily than a stereo signal, the level calculation module 76 sets the maximum value of the speech/music level of the monaural signal at a lower level than in the case of the stereo signal.

Besides, in the case of a drama program or a variety program other than music programs in which talk scenes and music scenes appear relatively distinctively, various sound effects tend to be present for the reason of stage directions, and sharp variations between a music section and a speech section frequently occur in a short time. In order to avoid the influence of sharp sound quality variations due to such variations, the level calculation module 76 refers to genre information of, e.g. EPG, and lowers the output speech/music levels of specified contents.

The sound quality correction module 80 can flexibly control the sound quality correction according to whether the input audio signal is a music signal or a speech signal, and whether the input audio signal is a stereo signal or a monaural signal. Specifically, the sound quality correction module 80 performs the sound quality correction process corresponding to the content of the signal, by using the above-described calculated music/speech level information.

For example, if the input audio signal is a stereo signal and has a high music level, the sound quality correction module 80 applies to the input audio signal such correction as to place importance on a stereophonic effect such as a surround effect. If the input audio signal is a monaural signal and has a high music level, the sound quality correction module 80 applies equalization-based correction to the input audio signal. If the input audio signal is a monaural signal and has a high speech level, the sound quality correction module 80 applies contour emphasis with central localizing to the input audio signal. If the input audio signal is a stereo signal and has a high speech level, the sound quality correction module 80 applies softer speech emphasis to the input audio signal. Thus, the sound quality correction module 80 can easily execute control in accordance with the number of channels of the input audio signal, and the height and stability of the speech/music level.

According to the present embodiment, the signal characteristic analysis module 70 can flexibly switch the sound quality correction in accordance with the characteristics of the input audio signal. The signal characteristic analysis module 70 can precisely detect the monaural signal as well as the stereo signal. In addition, the signal characteristic analysis module 70 can optimally detect an input audio signal which has a stereo signal format but has a monaural-like property, and an input audio signal which is a dual monaural signal. The signal characteristic analysis module 70 can express the likelihood of music/speech by level information, after stabilizing an instantaneous, local deviation in determination. Moreover, the signal characteristic analysis module 70 can calculate the speech/music level with a low delay and low load on the basis of a single determination formula, can stabilize the speech/music level according to the continuous time length, and can obtain speech and music as independent information. As a result, the signal characteristic analysis module 70 can flexibly switch the sound quality correction of the input audio signal in accordance with the distinction of monaural/stereo and speech/music.

The above-described modules may be realized by hardware, or may be realized by software with use of the CPU 64, etc.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio signal correction apparatus comprising:
a characteristic extraction module configured to determine whether an input audio signal is a monaural signal or a stereo signal, on the basis of channel information, and to extract a plurality of characteristic parameters for determining whether the input audio signal is a speech signal or a music signal;
a signal type determination module configured to calculate a speech/music discrimination score which indicates whether the input audio signal is close to the speech signal or the music signal, on the basis of the plurality of characteristic parameters;
a level calculation module configured to calculate, with use of the speech/music discrimination score, output levels of a degree of speech and a degree of music; and
a sound quality correction module configured to apply a sound quality correction process to the input audio signal on the basis of the output levels.

2. The apparatus of claim 1, wherein the characteristic extraction module is configured to determine, in a case where the input audio signal is a dual monaural signal, that the input audio signal is the monaural signal, and the characteristic extraction module is configured to determine that the input audio signal is the monaural signal in a case where the input audio signal has a format of the stereo signal and an LR power ratio of the input audio signal is less than a predetermined value.

3. The apparatus of claim 1, wherein the characteristic extraction module is configured to extract an LR power ratio as one of the plurality of characteristic parameters, in a case where the input audio signal is the stereo signal.

4. The apparatus of claim 1, wherein the signal type determination module is configured to multiply the plurality of characteristic parameters, respectively, by a plurality of weighting coefficients which are calculated by learning the plurality of characteristic parameters by using, as reference data, the speech signal and the music signal which are prepared in advance, and calculate, as the speech/music discrimination score, a sum of products of the multiplication between the plurality of characteristic parameters and the plurality of weighting coefficients.

5. The apparatus of claim 1, wherein the characteristic extraction module is configured to divide the input audio signal into a plurality of frames of a predetermined unit, and extract the plurality of characteristic parameters in association with each of the divided frames.

6. The apparatus of claim 5, wherein the level calculation module is configured to add a correction score to the speech/music discrimination score such that an intensity of correction for music is increased, in a case where the level calculation module has determined that the speech/music discrimination score of each of the divided frames, which has been calculated by the signal type determination module, is the music signal in succession for a predetermined number of times or more, and the level calculation module is configured to add a correction score to the speech/music discrimination score such that an intensity of correction for speech is increased, in a case where the level calculation module has determined that the speech/music discrimination score of each of the divided frames, which has been calculated by the signal type determination module, is the speech signal in succession for a predetermined number of times or more.

7. The apparatus of claim 6, wherein the level calculation module is configured to calculate the output levels which are smoothed by finding a moving average of the speech/music discrimination score that is corrected, with respect to the plurality of divided frames.

8. The apparatus of claim 7, wherein the level calculation module is configured to set, in a case where the input audio signal is the monaural signal, a maximum value of the output level at a lower value than in the case of the stereo signal, and vary the maximum value of the output level in accordance with a genre of the input audio signal.

9. An audio signal correction method comprising:
determining whether an input audio signal is a monaural signal or a stereo signal, on the basis of channel information, and extracting a plurality of characteristic parameters for determining whether the input audio signal is a speech signal or a music signal;
calculating a speech/music discrimination score which indicates whether the input audio signal is close to the speech signal or the music signal, on the basis of the plurality of characteristic parameters;
calculating, with use of the speech/music discrimination score, output levels of a degree of speech and a degree of music of the input audio signal; and
applying a sound quality correction process to the input audio signal on the basis of the output levels.
